(19) United States
(12) Patent Application Publication
(10) Pub. No.: US 2015/0120906 A1
(43) Pub. Date: Apr. 30, 2015

(54) AGENTLESS BASELINE PROFILE COMPILATION FOR APPLICATION MONITORING SOLUTION

(71) Applicant: International Business Machines Corporation, Armonk, NY (US)

(72) Inventors: Ann P. Dowling, Raleigh, NC (US); Nadeem Malik, Austin, TX (US); Carol Miller, St. Louis, MO (US)

(73) Assignee: International Business Machines Corporation, Armonk, NY (US)

(21) Appl. No.: 14/064,456

(22) Filed: Oct. 28, 2013

(51) Int. Cl. H04L 12/26

(52) U.S. Cl. CPC H04L 43/0876
USPC 709/224

(57) ABSTRACT

Aspects of the present invention provide a solution for monitoring execution of an application on a computer system. In an embodiment, a plurality of base operating values is obtained via an agentless process for each of a set of resource utilization variables that measure performance of the computer system. Based on these base operating values, an application profile for the computer system is compiled. This application profile can include an upper process control limit and a lower process control limit for each of the set of resource utilization variables. Execution of an application can be monitored by gathering operating values from the computer system during execution of the application and comparing the gathered values to the corresponding upper process control limits and the lower process control limits in the application profile.

### TECHNICAL FIELD

The subject matter of this invention relates generally to computer applications management. More specifically, aspects of the present invention provide a solution for monitoring execution of an application in a computer system.

### BACKGROUND

The cloud computing environment is an enhancement to the predecessor grid environment, whereby multiple grids and other computation resources may be further abstracted by a cloud layer, thus making disparate devices appear to an end-user as a single pool of seamless resources. These resources may include such things as physical or logical compute engines, servers and devices, device memory, and storage devices.

In such distributed computing environments (e.g., a cloud environment, grid environment, client/server environment, etc.), tasks that users wish to execute are often performed at locations that are remote from the user's location. Because of this, a user may have little or no access to information regarding the computer system on which the task is performed. Rather, the user may specify that an application should be executed to perform the task and later receive the results of the execution without any indication as to the performance (e.g., the operational runtime characteristics) of the application on the particular system on which the application was executed.

In order to provide more detailed information, monitoring software has been developed. This monitoring software often falls into two categories. Highly sophisticated monitoring software at the point of execution of the application can provide application level monitoring. In the alternative, more standard monitoring solutions can detect operating system level failures.

### SUMMARY

In general, aspects of the present invention provide a solution for monitoring execution of an application on a computer system. In an embodiment, a plurality of base operating values is obtained via an agentless process for each of a set of resource utilization variables that measure performance of the computer system. Based on these base operating values, an application profile for the computer system is compiled. This application profile can include an upper process control limit and a lower process control limit for each of the set of resource utilization variables. Execution of an application can be monitored by gathering operating values from the computer system during execution of the application and comparing the gathered values to the corresponding upper process control limits and the lower process control limits in the application profile.

A first aspect of the invention provides a method for monitoring execution of an application on a computer system, comprising: obtaining a plurality of base operating values for each of a set of resource utilization variables that measure performance of the computer system, the plurality of base operating values being obtained via an agentless process; compiling an application profile for the computer system based on the base operating values, the application profile including an upper process control limit and a lower process control limit for each of the set of resource utilization variables; gathering a utilization operating value for each of the set of resource utilization variables of the computer system during execution of the application on the computer system; and evaluating a performance of the application within the computer system based on a comparison of each of the set of the utilization operating values with a corresponding upper process control limit and a corresponding lower process control limit for each of the set of resource utilization variables.

A second aspect of the invention provides a system for monitoring execution of an application on a computer system, comprising at least one computer device that performs a method, comprising: obtaining a plurality of base operating values for each of a set of resource utilization variables that measure performance of the computer system, the plurality of base operating values being obtained via an agentless process; compiling an application profile for the computer system based on the base operating values, the application profile including an upper process control limit and a lower process control limit for each of the set of resource utilization variables; gathering a utilization operating value for each of the set of resource utilization variables of the computer system during execution of the application on the computer system; and evaluating a performance of the application within the computer system based on a comparison of each of the set of the utilization operating values with a corresponding upper process control limit and a corresponding lower process control limit for each of the set of resource utilization variables.

A third aspect of the invention provides a computer program product embodied in a computer readable medium for monitoring execution of an application on a computer system, which, when executed, performs a method comprising: obtaining a plurality of base operating values for each of a set of resource utilization variables that measure performance of the computer system, the plurality of base operating values being obtained via an agentless process; compiling an application profile for the computer system based on the base operating values, the application profile including an upper process control limit and a lower process control limit for each of the set of resource utilization variables; gathering a utilization operating value for each of the set of resource utilization variables of the computer system during execution of the application on the computer system; and evaluating a performance of the application within the computer system based on a comparison of each of the set of the utilization operating values with a corresponding upper process control limit and a corresponding lower process control limit for each of the set of resource utilization variables.

A fourth aspect of the present invention provides a method for deploying an application for monitoring execution of an application, comprising: providing a computer infrastructure being operable to: obtain a plurality of base operating values for each of a set of resource utilization variables that measure performance of the computer system, the plurality of base operating values being obtained via an agentless process; compile an application profile for the computer system based on the base operating values, the application profile including an upper process control limit and a lower process control limit for each of the set of resource utilization variables; gather a utilization operating value for each of the set of resource utilization variables of the computer system during execution of the application on the computer system; and evaluate a performance of the application within the computer system based on a comparison of each of the set of the utilization operating values with a corresponding upper process control limit and a corresponding lower process control limit for each of the set of resource utilization variables.

Still yet, any of the components of the present invention could be deployed, managed, serviced, etc., by a service provider who offers to implement passive monitoring in a computer system.

Embodiments of the present invention also provide related systems, methods and/or program products.

### BRIEF DESCRIPTION OF THE DRAWINGS

These and other features of this invention will be more readily understood from the following detailed description of the various aspects of the invention taken in conjunction with the accompanying drawings in which:

FIG. 1 shows an illustrative computer system according to embodiments of the present invention.

FIG. 2 shows a virtualized datacenter environment according to embodiments of the invention.

FIG. 3 shows an example virtual server environment according to embodiments of the invention.

FIG. 4 shows an example environment for obtaining operating values according to embodiments of the invention.

FIG. 5 shows an example device mapper table according to embodiments of the invention.

FIG. 6 shows an example flow diagram according to embodiments of the invention.

FIG. 7 shows an example flow diagram according to embodiments of the invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

Illustrative embodiments will now be described more fully herein with reference to the accompanying drawings, in which embodiments are shown. This disclosure may, however, be embodied in many different forms and should not be construed as limited to the embodiments set forth herein. Rather, these embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

As indicated above, aspects of the present invention provide a solution for monitoring execution of an application on a computer system. In an embodiment, a plurality of base operating values is obtained via an agentless process for each of a set of resource utilization variables that measure performance of the computer system. Based on these base operating values, an application profile for the computer system is compiled. This application profile can include an upper process control limit and a lower process control limit for each of the set of resource utilization variables. Execution of an application can be monitored by gathering operating values from the computer system during execution of the application and comparing the gathered values to the corresponding upper process control limits and the lower process control limits in the application profile.

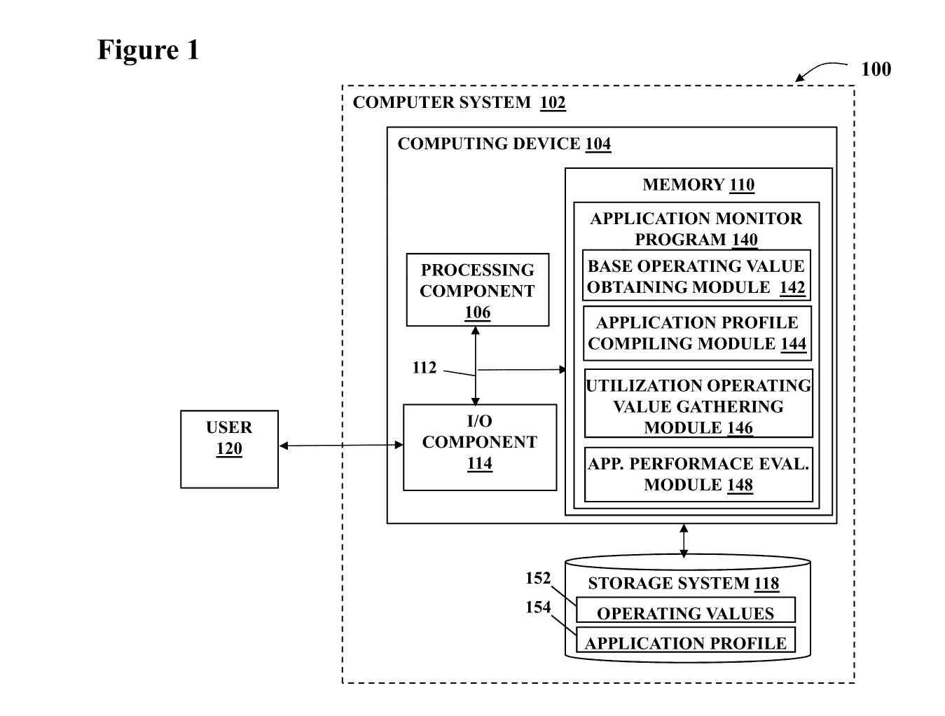

Turning to the drawings, FIG. 1 shows an illustrative environment 100 for monitoring execution of an application. To this extent, environment 100 includes a computer system 102 that can perform a process described herein in order to monitor execution of an application. In particular, computer system 102 is shown including a computing device 104 that includes an application monitor program 140, which makes computing device 104 operable to monitor execution of an application by performing a process described herein.

Computing device 104 is shown including a processing component 106 (e.g., one or more processors), a memory 110, a storage system 118 (e.g., a storage hierarchy), an input/output (I/O) component 114 (e.g., one or more I/O interfaces and/or devices), and a communications pathway 112. In general, processing component 106 executes program code, such as application monitor program 140, which is at least partially fixed in memory 110. To this extent, processing component 106 may comprise a single processing unit, or be distributed across one or more processing units in one or more locations.

Memory 110 also can include local memory, employed during actual execution of the program code, bulk storage (storage 118), and/or cache memories (not shown) which provide temporary storage of at least some program code in order to reduce the number of times code must be retrieved from bulk storage 118 during execution. As such, memory 110 may comprise any known type of temporary or permanent data storage media, including magnetic media, optical media, random access memory (RAM), read-only memory (ROM), a data cache, a data object, etc. Moreover, similar to processing component 116, memory 110 may reside at a single physical location, comprising one or more types of data storage, or be distributed across a plurality of physical systems in various forms.

While executing program code, processing component 106 can process data, which can result in reading and/or writing transformed data from/to memory 110 and/or I/O component 114 for further processing. Pathway 112 provides a direct or indirect communications link between each of the components in computer system 102. I/O component 114 can comprise one or more human I/O devices, which enable a human user 120 to interact with computer system 102 and/or one or more communications devices to enable a system user 120 to communicate with computer system 102 using any type of communications link.

To this extent, application monitor program 140 can manage a set of interfaces (e.g., graphical user interface(s), application program interface, and/or the like) that enable human and/or system users 120 to interact with application monitor program 140. Users 120 could include application developers, application testers, application end-users, and/or system administrators who want to monitor execution of an application on a computer system (e.g., one or more of a plurality of virtual servers), among others. Further, application monitor program 140 can manage (e.g., store, retrieve, create, manipulate, organize, present, etc.) the data in storage system 118, including, but not limited to operating values 152, application profile(s) 154 and/or the like, using any solution.

In any event, computer system 102 can comprise one or more computing devices 104 (e.g., general purpose computing articles of manufacture) capable of executing program code, such as application monitor program 140, installed thereon. As used herein, it is understood that “program code” means any collection of instructions, in any language, code, or notation, that causes a computing device having an information processing capability to perform a particular action either directly or after any combination of the following: (a) conversion to another language, code, or notation; (b) reproduction in a different material form; and/or (c) decompression. To this extent, application monitor program 140 can be embodied as any combination of system software and/or application software. In any event, the technical effect of computer system 102 is to provide processing instructions to computing device 104 in order to monitor execution of an application.

Further, application monitor program 140 can be implemented using a set of modules 142-148. In this case, a module 142-148 can enable computer system 102 to perform a set of tasks used by application monitor program 140, and can be separately developed and/or implemented apart from other portions of application monitor program 140. As used herein, the term “component” means any configuration of hardware, with or without software, which implements the functionality described in conjunction therewith using any solution, while the term “module” means program code that enables a computer system 102 to implement the actions described in conjunction therewith using any solution. When fixed in a memory 110 of a computer system 102 that includes a processing component 106, a module is a substantial portion of a component that implements the actions. Regardless, it is understood that two or more components, modules, and/or systems may share some/all of their respective hardware and/or software. Further, it is understood that some of the functionality discussed herein may not be implemented or additional functionality may be included as part of computer system 102.

When computer system 102 comprises multiple computing devices 104 (e.g., a client and one or more remotely located servers), each computing device 104 can have only a portion of application monitor program 140 fixed thereon (e.g., one or more modules 142-148). However, it is understood that computer system 102 and application monitor program 140 are only representative of various possible equivalent computer systems that may perform a process described herein. To this extent, in other embodiments, the functionality provided by computer system 102 and application monitor program 140 can be at least partially implemented by one or more computing devices that include any combination of general and/or specific purpose hardware with or without program code. In each embodiment, the hardware and program code, if included, can be created using standard engineering and programming techniques, respectively.

Regardless, when computer system 102 includes multiple computing devices 104, the computing devices can communicate over any type of communications link. Further, while performing a process described herein, computer system 102 can communicate with one or more other computer systems using any type of communications link. In either case, the communications link can comprise any combination of various types of wired and/or wireless links; comprise any combination of one or more types of networks; and/or utilize any combination of various types of transmission techniques and protocols.

As discussed herein, application monitor program 140 enables computer system 102 to monitor execution of an application. To this extent, application monitor program 140 is shown including a base operating value obtaining module 142, an application profile compiling module 144, a utilization operating value gathering module 146, and an application performance evaluation module 148.

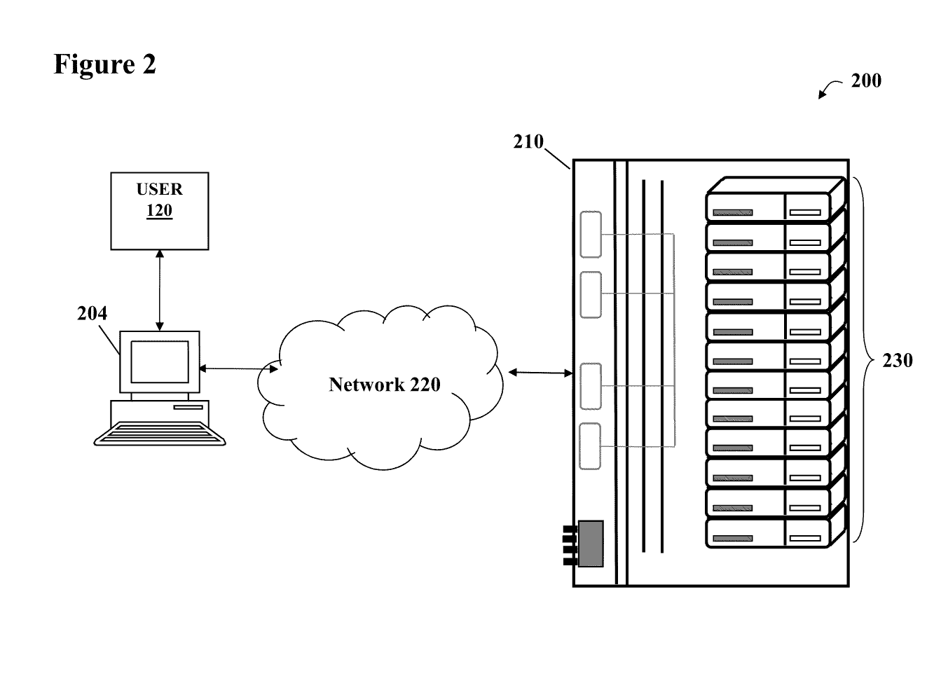

Referring now to FIG. 2, a virtualized datacenter environment 200 according to embodiments of the invention is shown. As shown, virtualized datacenter environment 200 has a physical server 210 that can be used to execute an application for user 120. As such, in the illustrated embodiment, all or a portion of the functions of application monitor program 140 (FIG. 1) can be performed on physical server 210, client 204, or a combination of the two. It should be understood the functions of application monitor program 140 (FIG. 1) are not limited to that the illustrated virtualized datacenter environment 200. Rather, other embodiments including, but not limited to, single system, peer-to-peer, client-server, grid computing, cloud computing, and/or any other environment are envisioned.

As illustrated, physical server 210 of virtualized datacenter environment 200 can be a server from any manufacturer that runs any platform that is adapted to run multiple instances of a virtual server 230. Virtualized datacenter environment 200 can also contain any number of related physical servers (not shown). These related physical servers can be connected with physical server 210 for communication purposes via a network 220. Network 220 can allow physical server 210 to communicate with related physical servers and/or physical servers to communicate with one another using any communications solution or solutions now known or later developed. Further, network 220 can allow a client 204 to communicate with physical server 210 and/or any related physical servers (e.g., to execute one or more applications thereon). In some embodiments, network 220 can operate on a cloud computing scale, providing, e.g., computation, software, data access, and other services that do not require end-user knowledge of the physical location and configuration of the network 220 that delivers the services.

In any case, as stated above, each instance of virtual server 230 on physical server 210 can operate simultaneously with other systems instances 230 while maintaining independence. This means that each of the instances of virtual server 230 operates independently of other instances of virtual server 230 and does not share information with other instances of virtual server 230 even though the instances of virtual server 230 operate on the same physical server 210. Owing to the characteristics of these instances of virtual server 230, a single physical server 210 can execute a very large number of instances of virtual server 230 concurrently. The independent operation of these instances of virtual server 230 ensures that the number of concurrent instances of virtual server 230 is only limited by the hardware constraints of physical server 210.

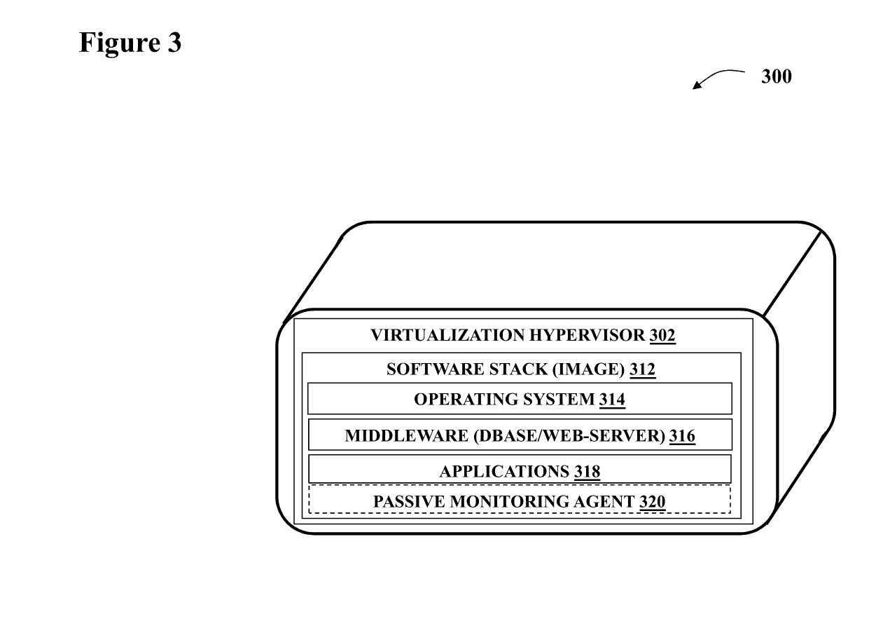

Referring now to FIG. 3, an example virtual server environment 300 according to embodiments of the invention is shown. In an embodiment, virtual server environment 300 can be included in virtual server 230 on physical server 210 (FIG. 2). It should be understood that virtual server environment 300 is different from a process virtual machine. A process virtual machine is a platform dependent engine, such as a Java Virtual Machine, that executes platform independent code written in a high-level programming language, such as Java, for performing a specific task (Java and Java Virtual Machine are a trademark of Sun Microsystems in the United States and/or elsewhere). In contrast, the virtual server environment 300 of the current invention is a virtual system that simulates an entire computing environment. To this extent, rather than performing only a single task, the virtual server environment 300 of the current invention is an environment within which a variety of tasks, functions, operations, etc., can be carried out by a user 120 (FIG. 1), such as by executing one or more applications thereon. As such, virtual server environment 300 can be made to simulate a stand-alone computer system in the eyes of a user 120 (FIG. 1).

To this extent, virtual server environment 300 includes a virtualization hypervisor 302 at the lowest level. Specifically, virtualization hypervisor 302 provides a platform that allows multiple “guest” virtual server 230 systems to run concurrently on the physical server 210 (FIG. 2). To this extent, virtualization hypervisor 302 provides an abstraction level between the hardware level of physical server 210 (FIG. 2) and the higher level software functions of each virtual server 310. In order to provide these software functions, each virtual server 310 can include a software stack 312, which can also be referred to as an image. Software stack 312 contains everything that is necessary to simulate a “guest” instance of a particular virtual server 310 on physical server 210 via virtualization hypervisor 302. To this extent, software stack 312 can provide an operating system 314, and middleware 316. This operating environment can be used to execute one or more applications 318.

The inventors of the current invention have discovered that the current solutions for monitoring execution of an application 318, e.g., in virtual server environment 300 can be improved. For example, current less-robust approaches can only detect failures at the operating system 314 level and fail to detect failures and/or performance issues at the application 318 level. Other current approaches include a passive monitoring agent 320 within the computer system (e.g., virtual server environment 300) that is executing application 318 or within the application 318, itself. These monitoring solutions (such as passive monitoring agent 320), which have the ability to monitor performance attributes of an application on a computer system (e.g., in real time), often fail to provide values to which these attributes can be easily compared. Because of this, such systems tend to be highly sophisticated, requiring highly trained experts to configure the solution initially, to analyze the provided attributes, and to provide ongoing performance tuning-type management.

Returning now to FIG. 1, computer system 102, executing base operating value obtaining module 142, obtains a plurality of base operating values 152 for each of a set of resource utilization variables that measure performance (e.g., operational runtime characteristics, such as CPU, memory, storage, and/or the like) of the computer system. Operating values obtaining module 142 obtains these base operating values 152 from the computer system via an agentless process (e.g., the taking of a snapshot/image of the computer system). These resource utilization variables can include any parameters that are now known or later developed for analyzing the performance of a computer system, including, but not limited to CPU utilization, memory utilization, file system utilization, disk input-output (IO), network IO, paging space utilization, VIO stats, number/type of running processes, and/or the like.

In an embodiment, the one or more resource utilization variables for which base operating values 152 are to be obtained can be selected by user 120, such as via a graphical user interface. Similarly, user 120 can select the number of times that the base operating values 152 are to be obtained for each resource utilization variable (e.g., via the graphical user interface). Additionally or in the alternative, user 120 can schedule (e.g., using the graphical user interface) the specific days/times (baseline monitoring times) that operating value obtaining module 142 will perform the task of obtaining the base operating values 152.

By allowing user 120 to schedule specific days/times, base operating value obtaining module 142 allows the user to schedule times that reflect the variations that might exist in the operating conditions of the computer system. For example, user 120 could generate a set of statistics that indicate the operating load on a particular computer system (e.g., virtual server environment) over time, and set base operating value obtaining module 142 to obtain the base operating values 152 at times when the computer system is expected to be at a minimum and/or maximum load. Conversely, value obtaining module 142 could use such statistics to automatically schedule the obtaining of base operating values 152 for times (e.g., expect minimum and maximum loads) that are most likely to yield the fullest possible range of values.

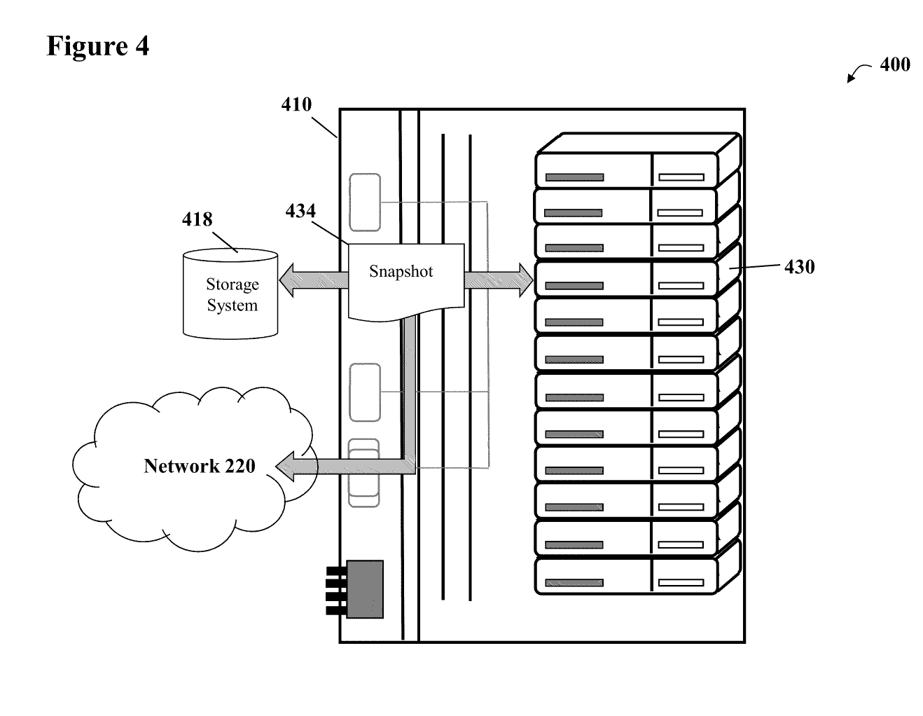

Referring now to FIG. 4 in conjunction with FIG. 1, an environment 400 in which base operating value obtaining module 142 can obtain base operating values 152 from a computer system 410 is shown according to an embodiment of the invention. In an embodiment, a snapshot 434 containing operating values 152 can be obtained from computer system 410 or a portion thereof (e.g., virtual server 430). This snapshot 434 can include an image of the entire computer system 410 or portion (e.g., virtual server 430). Additionally, or in the alternative, an indexing operation can be performed on the snapshot 434 to return only desired values, such as base operating values 152. In any case, once snapshot 434 has been taken, the snapshot 434 can be forwarded over network 220 for processing. Alternatively, snapshots can be stored in storage system 418 and forwarded in batch with other snapshots 434. Additionally or in the alternative, computer system 410 can perform processing and results of the processing can be forwarded. This processing could include parsing, indexing, etc., of snapshot 434 to retrieve base operating values 152 from snapshot 434, performing any or all of the processes to be described below, and/or any other processing that is desired.

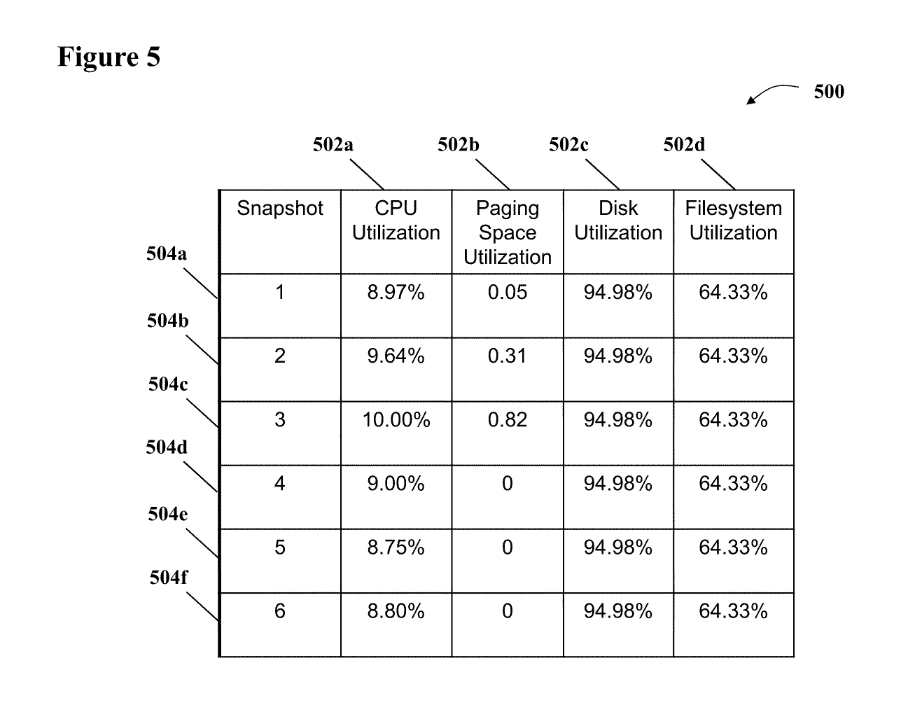

Referring now to FIG. 5, a set of base operating values 500 according to an embodiment of the invention is shown. As shown, base operating values 500 have been obtained for each of four different resource utilization variables 502a-d. It should be understood that the types of resource utilization variables 502a-d illustrated herein should not be taken as limiting. Rather, base operating values 500 could be obtained for any measurable attribute that can be used to measure performance (e.g., operational runtime characteristics) of the computer system, including but not limited to: cpu utilization, memory utilization, filesystem utilization, disk I/O, network I/O, paging space utilization, VIO stats, number/type of running processes and/or the like. In any case, as illustrated, six different sets 504a-f of base operating values 500 (e.g., from snapshots) have been obtained for each of the resource utilization variables 502a-d. To this extent, each of the sets 504a-f includes a resource operating value for each of the resource utilization variables 502a-d at a particular time (e.g., at each of the baseline monitoring times previously set by the user). The illustrated number of sets 504a-f of base operating values 500 in the illustrated embodiment is believed to provide a sufficient number of values to satisfy the purposes of this invention. It should, however, be understood that a greater or lesser number of different sets 504a-f of base operating variables 500 could be used.

Returning again to FIG. 1, computer system 102, executing application profiling compiling module 144, compiles an application profile 154 for the computer system 210 based on the base operating values 152 obtained by base operating value obtaining module 142. Application profile 154 can act as a baseline measurement of the performance of computer system 210. To this extent, the set of base operating values 152 obtained for each of the resource utilization variables can be used to compile a profile for that particular variable. This profile can include an upper process control limit and a lower process control limit for each of the resource utilization variables that is calculated using the set of base operating values 152 for that resource utilization variable.

In an embodiment, this upper process control limit and lower process control limit can be calculated using a moving range control limit calculation that uses the obtained base resource operating values 152 for each of the resource utilization variables. For example, the absolute difference can be calculated between each consecutive pair of the obtained base resource operating values 152 corresponding to a particular resource utilization variable. For example, referring to FIG. 5, the calculating of absolute differences for the set 504a-f of base resource operating values 500 corresponding to CPU Utilization 502a (e.g., 8.97, 9.64, 10, 9, 8.75, 8.80) would yield values of 0.67 (9.64−8.97), 0.36 (10−9.64), 1 (10−9), 0.25 (9−8.75), and 0.05 (8.80−8.75). These absolute differences can, in turn, be averaged to get an average difference over all of the resource operating values 152, which in the illustrated example would be (0.67+0.36+1+0.25+0.05)/5=0.47.

This average difference can be multiplied by a weighing factor to get a weighted average difference. Weighting factor can be based on a standard deviation (e.g., 2^{nd} deviation) or using any other solution for calculating a weight that is now known or later developed. This weighted average difference can be added to an average of the obtained base resource operating values 152 (average resource operating value) to get the upper process control limit. Similarly, the weighted average difference can be subtracted from the average resource operating value to get the lower process control limit. In the illustrated example, the average resource operating value would be (8.97+9.64+10+9+8.75+8.00)/6=9.19. Assuming a weighting factor of 2.66, the upper process control limit for CPU Utilization 502a would be 9.19+(2.66*0.47)=10.44. Similarly, the lower process control limit for CPU Utilization 502a would be 9.19−(2.66*0.47)=7.94.

Referring again to FIG. 1 in conjunction with FIG. 2, FIG. 3 and FIG. 5, computer system 102, executing utilization operating value gathering module 146, gathers a utilization operating value 152 for each of the set of resource utilization variables of the computer system 210. Utilization operating value 152 can be gathered via the same agentless process that was used to obtain base operating values 500. For example, the same processes referred to in conjunction with the environment 400 of FIG. 4 can be used to create a snapshot 434 of computer system 410, and the snapshot 434 can be stored in storage system 418 and/or communicated over network 210 as needed. Additionally, or in the alternative, utilization operation value 152 can be gathered via passive monitoring agent 320 that runs within the virtual server environment 300 within which the application is being executed and/or within the application itself. Such a solution can allow a number of utilization operation values 152 to be quickly gathered during execution of the application and/or can allow for streaming utilization operation values 152 to be gathered, such as in real time.

In any case, utilization operating values 152 differ from base operating values 500 in that utilization operating values 152 are gathered from the computer system 210 during execution of the application, which user 120 wishes to monitor, on the computer system 210. In this way, utilization operating value gathering module 146 can provide user 120 with accurate operating value 152 data as the application is being executed. This data can be provided without adversely impacting operation of the computer system 210 and without the need to perform extensive configuration and/or maintenance operations.

Referring now to FIG. 1 in conjunction with FIG. 2, FIG. 3, and FIG. 5, computer system 102, executing application performance evaluation module 148, evaluates the performance of the application within the computer system 210 using the operating values 152. To do so, application performance evaluation module 148 can compare the utilization operating value 152 gathered by utilization operating value gathering module 146 with the application profile 154 compiled by application profile compiling module 144. This comparison can be performed locally, such as by passive monitoring agent running within virtual server environment. In the alternative, the utilization operating value 152 can be transferred to a remote system where the application profile 154 is being stored, and the comparison can be performed at that location. In any case, the comparison can analyze the utilization operating value 152 corresponding to a particular resource utilization variable with respect to the upper control limit and lower control limit computed for that resource utilization variable based on the base operating values 152.

For example, in the above example, a gathered utilization operating value 152 for CPU Utilization 502a that is at, above, or within a certain percent of the calculated upper control limit of 10.44 could indicate a malfunction in the execution of the application on the computer system 210 (e.g., an incorrect usage of memory resources). Similarly, a gathered utilization operating value 152 for CPU Utilization 502a that is at, below, or within a certain percent of the calculated lower control limit of 10.44 could also indicate a malfunction in the execution of the application on the computer system 210 (e.g., not all necessary memory resources being allocated).

This evaluation can allow the user 120 to have more information regarding the execution of the application than has previously been available. For example, user 120 can receive an alert in the case that the evaluation indicates that the application is not performing correctly. User 120 can then evaluate the application to determine whether a problem exists in the application and/or can alert an administrator of the computer system 210 of a potential problem therewith. Additionally or in the alternative, user 120 can specify the gathering of a series of utilization operating values 152 over time (e.g., by the taking of periodic snapshots of the computer system 210 during execution of the application). These utilization operating values 152 can be analyzed, aggregated, used to compute statistics, used to compile trends, and/or the like, allowing user 120 to be proactive in the management of the application. Because the application profile 154 has previously been compiled from the base operating values using an automated process, this evaluation can be performed simply and repeatedly without the need for extensive human intervention to perform analysis and/or provide ongoing performance tuning-type management.

Further, the user 120 can use this data to determine whether the upper control limits and/or lower control limits are still valid and, if the user 120 believes this not to be the case, to schedule a new set of times (e.g., removed in time from the first set of times) for obtaining base operating values 152 from the computer system 210, obtain the updated set of base operating values 152 at those times, and use the updated base operating values 152 to compute a replacement application profile that replaces the previously used application profile. This replacement application profile can then be used to perform the evaluating of the performance of current and/or future utilization operating values 152.

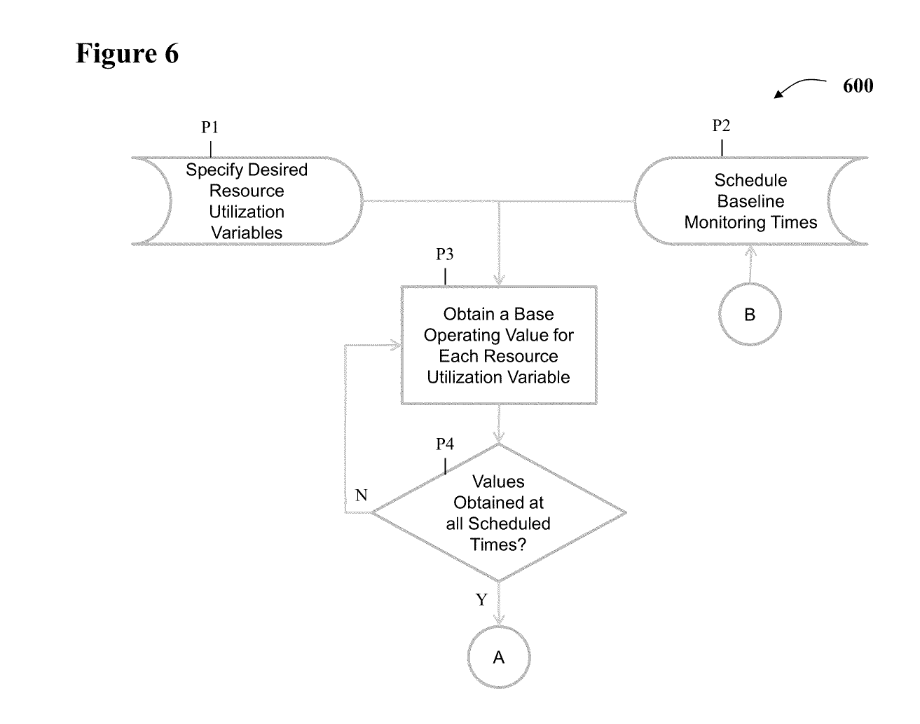

Referring now to FIG. 6, in conjunction with FIG. 1, an example flow diagram according to embodiments of the invention is shown. As illustrated, in P1, a set of resource utilization variables 502a-d can be specified. This specifying can be done using a pre-existing list, can be entered/selected by a user 120, such as via a graphical user interface, and/or the like. In P2, a set of baseline monitoring times can be specified. These baseline monitoring times can be entered/selected by a user 120, such as via a graphical user interface; can be automatically generated (e.g., based on past operating statistics of the computer system 210 (FIG. 2)); and/or the like. In P3, base operating value obtaining module 142, as executed by computer system 102, obtains a base operating value 152 for each of the specified resource utilization variables. These base operating values 152 are obtained via an agentless process (e.g., taking a snapshot of the computer system 210 (FIG. 2). In P4, a determination is made as to whether base operating values 152 have been obtained at all scheduled times. If all base operating values 152 have not been obtained, process returns to P3 and the next set of base operating values 152 is obtained at the next scheduled time. Otherwise, process moves to A.

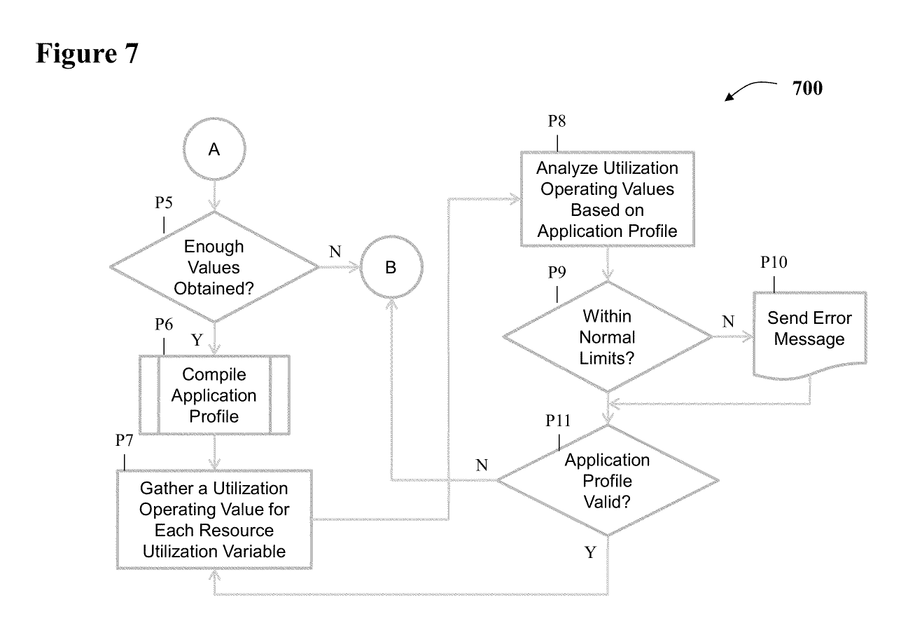

Turning now to FIG. 7 in view of FIG. 1, an example flow diagram according to embodiments of the invention is shown. As illustrated, process moves from A to P5, where a determination is made as to whether enough (e.g., 6 or more) sets of base operating values 152 have been obtained. If not, process branches to B and back to P2 (FIG. 6) for more baseline monitoring times to be scheduled. Otherwise, in P6, application profile compiling module 144, as executed by computer system 102, compiles an application profile 154 for the computer system 210 (FIG. 2) based on the obtained base operating values 152. This application profile 154 includes an upper process control limit and a lower process control limit, which can be calculated using a moving range control limit calculation. In P7, utilization operating value gathering module 146, as executed by computer system 102, gathers a utilization operating value 152 for each of the specified resource utilization variables from the computer system 210 during execution of the application on the computer system. This gathering can be done using a passive monitoring agent 320 (FIG. 3) running within the virtual server environment 300, can utilize the same agentless process used to obtain the base operating values 152, or can be done using any other solution now known or later developed. In P8, application performance evaluation module 148, as executed by computer system 102, analyzes the utilization operating values 152 based on the application profile 154 (e.g., the upper process control limit and the lower process control limit) to evaluate the performance (e.g., the operational runtime characteristics) of the application within the computer system 210 (FIG. 2), and, in P9, a determination is made as to whether the most recently gathered utilization operating values 152 are within normal limits. If the performance of the application is outside normal limits, in P10, an error message can be sent (e.g., to user 120, an administrator of the computer system 210, etc.). In any case, in P11, a determination can be made as to whether the application profile 154 is still valid. If not, execution flows to B and back to P2 (FIG. 6) for scheduling of a new set of baseline monitoring times. Otherwise, execution flows back to P7, where the next set of utilization operating values 152 are gathered at the next scheduled time.

While shown and described herein as a method and system for monitoring execution of an application, it is understood that aspects of the invention further provide various alternative embodiments. For example, in one embodiment, the invention provides a computer program fixed in at least one computer-readable medium, which when executed, enables a computer system to monitor execution of an application. To this extent, the computer-readable medium includes program code, such as application monitor program 140 (FIG. 1), which implements some or all of a process described herein. It is understood that the term “computer-readable medium” comprises one or more of any type of tangible medium of expression, now known or later developed, from which a copy of the program code can be perceived, reproduced, or otherwise communicated by a computing device. For example, the computer-readable medium can comprise: one or more portable storage articles of manufacture; one or more memory/storage components of a computing device; and/or the like.

In another embodiment, the invention provides a method of providing a copy of program code, such as application monitor program 140 (FIG. 1), which implements some or all of a process described herein. In this case, a computer system can process a copy of program code that implements some or all of a process described herein to generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of program code that implements some or all of a process described herein, which includes a computer system receiving the set of data signals described herein, and translating the set of data signals into a copy of the computer program fixed in at least one computer-readable medium. In either case, the set of data signals can be transmitted/received using any type of communications link.

In still another embodiment, the invention provides a method of generating a system for remediating a migration-related failure. In this case, a computer system, such as computer system 120 (FIG. 1), can be obtained (e.g., created, maintained, made available, etc.) and one or more components for performing a process described herein can be obtained (e.g., created, purchased, used, modified, etc.) and deployed to the computer system. To this extent, the deployment can comprise one or more of: (1) installing program code on a computing device; (2) adding one or more computing and/or I/O devices to the computer system; (3) incorporating and/or modifying the computer system to enable it to perform a process described herein; and/or the like.

The terms “first,” “second,” and the like, if and where used herein do not denote any order, quantity, or importance, but rather are used to distinguish one element from another. The modifier “approximately”, where used in connection with a quantity is inclusive of the stated value and has the meaning dictated by the context (e.g., includes the degree of error associated with measurement of the particular quantity). The suffix “(s)” as used herein is intended to include both the singular and the plural of the term that it modifies, thereby including one or more of that term (e.g., the metal(s) includes one or more metals).

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A method for monitoring execution of an application on a computer system, comprising:
obtaining a plurality of base operating values for each of a set of resource utilization variables that measure performance of the computer system, the plurality of base operating values being obtained via an agentless process;
compiling an application profile for the computer system based on the base operating values, the application profile including an upper process control limit and a lower process control limit for each of the set of resource utilization variables;
gathering a utilization operating value for each of the set of resource utilization variables of the computer system during execution of the application on the computer system; and
evaluating a performance of the application within the computer system based on a comparison of each of the set of the utilization operating values with a corresponding upper process control limit and a corresponding lower process control limit for each of the set of resource utilization variables.

2. The method of claim 1, further comprising:
scheduling a plurality of baseline monitoring times, each of the plurality of baseline monitoring times anticipated to occur during a different operating load of the computer system,
wherein the obtaining includes taking a snapshot of the computer system that includes a resource operating value for each of the resource utilization variables at each of the baseline monitoring times, and
wherein the gathering includes taking a snapshot of the computer system that includes a utilization operating value for each of the resource utilization variables as the application is being executed on the computer system.

3. The method of claim 2, further comprising:
scheduling a second plurality of the baseline monitoring times that are removed in time from the set of baseline monitoring times;
taking a second set of the snapshots at each of the second plurality of the baseline monitoring times;
replacing the application profile with a replacement application profile based on updated resource operating values in the second set of snapshots; and
performing the evaluating of the performance of the application with respect to the replacement application profile.

4. The method of claim 1, wherein the compiling of the application profile further comprises performing a moving range control limit calculation for each of the resource utilization variables based on the plurality of base resource operating values.

5. The method of claim 4, wherein the performing of the moving range control limit calculation further comprises:
calculating an absolute difference between each consecutive resource operating value pair in the plurality of resource operating values;
averaging all calculated absolute differences to get an average difference;
averaging the plurality of resource operating values to get an average resource operating value;
multiplying the average difference by a weighting factor to get a weighted average difference;
adding the weighted average difference to the average resource operating value to get the upper process control limit; and
subtracting the weighted average difference from the average resource operating value to get the lower process control limit.

6. The method of claim 1, further comprising sending an error message to a user of the application in response to a determination that the utilization operating value is outside a range defined by the upper process control limit and the lower process control limit.

7. The method of claim 1, wherein the computer system includes a server and the compiling and the evaluating are performed on a client of a user of the application.

8. A system for monitoring execution of an application on a computer system, comprising at least one computer device that performs a method, comprising:
obtaining a plurality of base operating values for each of a set of resource utilization variables that measure performance of the computer system, the plurality of base operating values being obtained via an agentless process;
compiling an application profile for the computer system based on the base operating values, the application profile including an upper process control limit and a lower process control limit for each of the set of resource utilization variables;
gathering a utilization operating value for each of the set of resource utilization variables of the computer system during execution of the application on the computer system; and
evaluating a performance of the application within the computer system based on a comparison of each of the set of the utilization operating values with a corresponding upper process control limit and a corresponding lower process control limit for each of the set of resource utilization variables.

9. The system of claim 8, the method further comprising:
scheduling a plurality of baseline monitoring times, each of the plurality of baseline monitoring times anticipated to occur during a different operating load of the computer system,
wherein the obtaining includes taking a snapshot of the computer system that includes a resource operating value for each of the resource utilization variables at each of the baseline monitoring times, and
wherein the gathering includes taking a snapshot of the computer system that includes a utilization operating value for each of the resource utilization variables as the application is being executed on the computer system.

10. The system of claim 9, the method further comprising:
scheduling a second plurality of the baseline monitoring times that are removed in time from the set of baseline monitoring times;
taking a second set of the snapshots at each of the second plurality of the baseline monitoring times;
replacing the application profile with a replacement application profile based on updated resource operating values in the second set of snapshots; and
performing the evaluating of the performance of the application with respect to the replacement application profile.

11. The system of claim 8, wherein the compiling of the application profile further comprises performing a moving range control limit calculation for each of the resource utilization variables based on the plurality of base resource operating values.

12. The system of claim 11, wherein the performing of the moving range control limit calculation further comprises:
calculating an absolute difference between each consecutive resource operating value pair in the plurality of resource operating values;
averaging all calculated absolute differences to get an average difference;
averaging the plurality of resource operating values to get an average resource operating value;
multiplying the average difference by a weighting factor to get a weighted average difference;
adding the weighted average difference to the average resource operating value to get the upper process control limit; and
subtracting the weighted average difference from the average resource operating value to get the lower process control limit.

13. The system of claim 8, the method further comprising sending an error message to a user of the application in response to a determination that the utilization operating value is outside a range defined by the upper process control limit and the lower process control limit.

14. The system of claim 8, wherein the computer system includes a server and the compiling and the evaluating are performed on a client of a user of the application.

15. A computer program product embodied in a computer readable medium for monitoring execution of an application on a computer system, which, when executed, performs a method comprising:
obtaining a plurality of base operating values for each of a set of resource utilization variables that measure performance of the computer system, the plurality of base operating values being obtained via an agentless process;
compiling an application profile for the computer system based on the base operating values, the application profile including an upper process control limit and a lower process control limit for each of the set of resource utilization variables;
gathering a utilization operating value for each of the set of resource utilization variables of the computer system during execution of the application on the computer system; and
evaluating a performance of the application within the computer system based on a comparison of each of the set of the utilization operating values with a corresponding upper process control limit and a corresponding lower process control limit for each of the set of resource utilization variables.

16. The program product of claim 15, the method further comprising:
scheduling a plurality of baseline monitoring times, each of the plurality of baseline monitoring times anticipated to occur during a different operating load of the computer system,
wherein the obtaining includes taking a snapshot of the computer system that includes a resource operating value for each of the resource utilization variables at each of the baseline monitoring times, and
wherein the gathering includes taking a snapshot of the computer system that includes a utilization operating value for each of the resource utilization variables as the application is being executed on the computer system.

17. The program product of claim 16, the method further comprising:
scheduling a second plurality of the baseline monitoring times that are removed in time from the set of baseline monitoring times;
taking a second set of the snapshots at each of the second plurality of the baseline monitoring times;
replacing the application profile with a replacement application profile based on updated resource operating values in the second set of snapshots; and
performing the evaluating of the performance of the application with respect to the replacement application profile.

18. The program product of claim 15, wherein the compiling of the application profile further comprises performing a moving range control limit calculation for each of the resource utilization variables based on the plurality of base resource operating values.

19. The program product of claim 18, wherein the performing of the moving range control limit calculation further comprises:
calculating an absolute difference between each consecutive resource operating value pair in the plurality of resource operating values;
averaging all calculated absolute differences to get an average difference;
averaging the plurality of resource operating values to get an average resource operating value;
multiplying the average difference by a weighting factor to get a weighted average difference;
adding the weighted average difference to the average resource operating value to get the upper process control limit; and
subtracting the weighted average difference from the average resource operating value to get the lower process control limit.

20. The program product of claim 15, the method further comprising sending an error message to a user of the application in response to a determination that the utilization operating value is outside a range defined by the upper process control limit and the lower process control limit.
